(19) United States
(12) Patent Application Publication
(10) Pub. No.: US 2013/0250888 A1
(43) Pub. Date: Sep. 26, 2013

(54) RADIO COMMUNICATION TERMINAL, RADIO COMMUNICATION BASE STATION AND COMMUNICATION METHODS THEREOF, PROGRAM FOR CARRYING OUT THE COMMUNICATION METHOD AND MEDIUM FOR STORING THE PROGRAM

(71) Applicant: FUJITSU LIMITED, Kawasaki-shi (JP)

(72) Inventor: Yanling LU, Beijing (CN)

(73) Assignee: FUJITSU LIMITED, Kawasaki-shi (JP)

(21) Appl. No.: 13/892,874

(22) Filed: May 13, 2013

Related U.S. Application Data
(63) Continuation of application No. PCT/CN2010/001929, filed on Nov. 30, 2010.

(51) Int. Cl. H04W 72/04

(52) U.S. Cl. CPC H04W 72/0453
USPC 370/329

(57) ABSTRACT

A radio communication terminal, radio communication base station and communication methods thereof, program for carrying out the communication method and medium for storing the program. The radio communication terminal for communicating with a radio communication base station includes: a transmitting unit configured to transmit random access preambles to the radio communication base station; a receiving unit configured to receive response messages from the radio communication base station; and a controlling unit configured to generate a random access temporary identifier to obtain the response messages, so as to realize synchronization; wherein the controlling unit controls the transmitting unit to transmit the random access preambles in any one of a plurality of carriers; and the controlling unit generates the random access temporary identifier according to a position of a PRACH used for transmitting the random access preambles in a carrier and the carrier where the PRACH is located.

### CROSS-REFERENCE TO RELATED APPLICATIONS

This application is based on the PCT Application No. PCT/CN2010/001929, filed on Nov. 30, 2010 and now pending. The contents of the application are wholly incorporated herein by reference.

### TECHNICAL FIELD

The present invention relates to the field of radio communication, and in particular to a radio communication terminal, radio communication base station and communication methods thereof, program for carrying out the communication method and medium for storing the program.

### BACKGROUND ART

In a radio communication system, a user equipment (UE) needs to perform uplink random access so as to realize uplink synchronization. The UE can realize uplink data transmission, downlink data transmission and message transmission with an evolved node base station (eNB) only when uplink synchronization is realized.

A random access technology is used in a 3GPP long-term evolution (LTE) system to obtain uplink synchronization. A random access procedure includes two types: a random access procedure based on contention and a random access procedure based on non-contention. In the random access procedure based on non-contention, the UE uses a random access preamble and a physical random access channel (PRACH) specified by the eNB to perform the random access. And in the random access procedure based on contention, the UE may select a random access preamble and a PRACH to perform the random access.

FIG. 1 shows a random access procedure based on contention in the prior art.

In an existing radio communication system based on 3GPP release 9 (refer to non-patent document 1), when the UE performs random access with the eNB, as shown in FIG. 1, in step S101, the UE transmit a random access preamble arbitrarily selected from selectable preambles to the eNB using an uplink PRACH randomly selected.

The moment, after the preamble is transmitted and it is furthermore delayed by three subframes, is taken as a start of a receiving window of a random access response with a prescribed length. The length of the receiving window is semi-static, and the eNB may notify, via a broadcast message cyclically or via a specific message, the length of a receiving window of the local cell to the UE; hence, the UE has already obtained the length of the receiving window before initiating a random access.

In step S102, the receiving window of the random access response message is started. After receiving the preamble, the eNB may make a response in the window and transmit random access response (RAR) information to the UE in the receiving window of the random access response, or it may not make a response and not transmit RAR information to the UE in the receiving window of the random access response.

The response signal transmitted by the eNB to the UE contains information on a physical downlink control channel (PDCCH) indicating the position of the RAR information in a subframe. The UE may obtain the position of the RAR only after it decodes the PDCCH transmitted to it.

The PDCCH is used to indicate resource allocation in uplink and downlink and other control. The PDCCH is scrambled using certain codewords. Different scramble codewords are used for PDCCHs with different applications and being transmitted to different UEs. In a random access procedure, an eNB uses a random access-radio network temporary identifier (RA-RNTI) to scramble a PDCCH. In the random access procedure, if the UE is to decode a PDCCH, it must obtain the RA-RNTI first.

In step S103, the response window starts. Once the response window starts, the UE needs to use the RA-RNTI to detect the PDCCH for each subframe within the response window. The RA-RNTI may be calculated by using the following formula:

RA-RNTI=1+t_{—}id+10*f_{—}id (13);

where, t_id is the index of the first subframe where a specified PRACH is located, as 10 subframes being contained in each frame, 0≦t_id<10; and f_id is the index of the specified PRACH within that subframe, in ascending order of frequency domain, and it is defined as 0≦f_id<6.

It can be seen from Formula (13) that the UE may obtain the RA-RNTI by following Formula (13) according to a particular position (subframe number in time domain, and the index of the PRACH in frequency domain) for transmitting preambles. As shown by the arrow in S102, after using the RA-RNTI to detect the scrambled PDCCH transmitted by the eNB, the UE may acquire the position of the RAR message.

The UE further decodes the RAR message to judge whether the preamble transmitted by the UE is contained in the RAR message. And if the RAR message contains the preamble transmitted by the UE, step S104 is performed for identifying the identity of the UE.

If the UE does not find the preamble transmitted by itself in the RAR message, the UE continually decodes within the receiving window of the RAR, until it finds the preamble transmitted by itself, or the receiving window of the RAR is terminated, and transmission of preambles fails this time.

In step S104, the UE transmits a message msg3 in an uplink bandwidth allocated in the RAR message. The message msg3 contains information for identifying the identity of the UE, so as to distinguish different UEs transmitting identical preambles in identical PRACHs.

In step S105, the eNB acknowledges the identity of the UE after receiving the message msg3. After acknowledging the identity of the UE, the eNB transmits a message msg4 to the UE. After receiving the msg4, the UE obtains the acknowledgement of itself by the eNB and thinks that the uplink has been synchronized, and the random access procedure is terminated. Thereafter, the UE may transmit data in the bandwidth allocated in the RAR message.

As described above, the RA-RNTI is a key parameter of a random access procedure for a UE.

Furthermore, in an existing radio communication system, such as that in Rel. 8 of LTE, a UE supports an operational bandwidth of at most 20 MHz. A carrier aggregation (CA) technology is proposed for satisfying requirements of a 4G radio communication system and in face of demands of future high-rate high-bandwidth services. Wherein a UE may operate within a bandwidth of up to 100 MHz, and multiple carriers may be aggregated. In a CA system of Rel. 10 of LTE, for each UE, one carrier in the aggregated carriers is defined as a primary carrier, and others are defined as secondary carriers. Some important procedures (such as a random access procedure) and uplink feedback (such as a physical uplink control channel) are only performed in the primary carrier, and uplink and downlink data and some control information may be transmitted in the secondary carriers.

In the Rel. 10 of LTE, as the random access procedure occurs only in the primary carrier, the system is compatible with a non-CA system. However, in CA systems described the Rel. 11 and subsequent releases of LTE, a random access procedure may occur in the secondary carriers, and multiple random access procedures may occur simultaneously. At this moment, in the prior art as shown in FIG. 1, as carrier information is not taken into consideration in the RA-RNTI, the PRACH cannot be uniquely identified, and an error will occur.

FIG. 2 shows a timing sequence of a problem occurred when a random access procedure of the prior is applied to a CA system.

In steps S201 and S202, multiple terminals UE-A and UE-B transmit identical preambles in PRACHs located in identical positions of different carriers.

In steps S203 and S204, for the preambles transmitted via multiple carriers, the eNB transmits RAR messages. At this moment, if the eNB uses an existing RA-RNTI calculation method, only one RA-RNTI value may be calculated. Such an RA-RNTI value is used to scramble the PDCCH, and the PDCCH is used to indicate a corresponding RAR message.

In steps S205 and S206, after the terminals UE-A and UE-B receive the RAR messages, if they find that the preambles transmitted by themselves are contained in the RAR messages, both the terminals UE-A and UE-B judge that the preambles transmitted by themselves are successfully received, and then transmit messages msg3 within the bandwidth allocated in the RAR messages. At this moment, both the terminals UE-A and UE-B judge that the preambles transmitted by themselves are successfully received, and if both of the terminals transmit messages msg3 in the bandwidth allocated in the RAR messages in identical carriers, it is obvious that the two messages msg3 will collide. If the two terminals transmit messages msg3 in the bandwidth allocated in the RAR messages in the respective carriers for transmitting preambles, in case that the eNB actually allocates a bandwidth for a message msg3 in only one of the carriers, on the other carrier, the message msg3 transmitted by the other terminal will bring unnecessary interference to other users in the other carrier. If the eNB indeed allocates bandwidths located in identical positions in the two carriers at the same time, the scheduling performed by the eNB shall be limited, since it needs to select bandwidths located in identical positions in different carriers. And at the same time, as the causes for initiating random accesses are different from each other, the bandwidths needed by the messages msg3 are different. In such a case, if bandwidths located in identical positions with the same sizes are allocated for all the terminals, resources will be wasted if the bandwidths are oversize, and messages msg3 cannot be normally transmitted if the bandwidths are undersize. Therefore, a most effective manner is to flexibly allocate bandwidths to the terminals respectively, that is, to reply with response messages respectively.

The above problem also occurs in a case where the same UE transmits identical preambles in PRACHs located in identical positions of different carriers.

### Non-Patent Documentations

1. 3GPP TS 36.321 V9.3.0 (2010-06) Medium Access Control (MAC) Protocol specification (Release 9); and
2. R2-106854 Corrections and new agreements on Carrier Aggregation Nokia Siemens Networks

### Patent Documentations

1. Chinese Patent Publication No. CN101742684A Gazette;
2. Chinese Patent Publication No. CN101674661A Gazette;
3. Chinese Patent Publication No. CN101742682A Gazette.

### SUMMARY

Disclosures herein are proposed in light of the problems existing in the prior art, with an object being to provide a radio communication terminal, radio communication base station and communication methods thereof, program for carrying out the communication method and medium for storing the program, wherein random access may be effectively performed in a CA system, and synchronization may be realized.

Various disclosures herein provide a radio communication terminal for communicating with a radio communication base station, comprising: a transmitting unit configured to transmit random access preambles to the radio communication base station; a receiving unit configured to receive response messages from the radio communication base station; and a controlling unit configured to generate a random access temporary identifier to obtain the response messages, so as to realize synchronization; wherein the controlling unit controls the transmitting unit to transmit the random access preambles in any one of a plurality of carriers; and the controlling unit generates the random access temporary identifier according to a position of a PRACH used for transmitting the random access preambles in a carrier and the carrier where the PRACH is located.

Various disclosures herein also provide a radio communication base station for communicating with a radio communication terminal, comprising: a receiving unit configured to receive random access preambles from the radio communication terminal; a controlling unit configured to generate a random access temporary identifier of the radio communication terminal and response messages for the random access preambles, and use the random access temporary identifier to scramble the response messages; and a transmitting unit configured to transmit scrambled response messages to the radio communication terminal; wherein the controlling unit controls the receiving unit to receive random access preambles in multiple carriers, and the controlling unit generates the random access temporary identifier of the radio communication terminal according to a position of a PRACH used for transmitting random access preambles by the radio communication terminal in a carrier and the carrier where the PRACH is located.

Various disclosures herein further provide a radio communication terminal communication method for performing communication between a radio communication terminal and a radio communication base station, comprising the steps of: in performing random access, transmitting random access preambles to the radio communication base station by the radio communication terminal in any one of a plurality of carriers, and generating a random access temporary identifier by the radio communication terminal according to a position of a PRACH used for transmitting the random access preambles in a carrier and the carrier where the PRACH is located.

Various disclosures herein further provide a radio communication base station communication method for performing communication between a radio communication base station and a radio communication terminal, comprising the steps of: in performing random access, receiving in a plurality of carriers, by the radio communication base station, random access preambles transmitted by the radio communication terminal, and generating a random access temporary identifier of the radio communication terminal by the radio communication base station according to a position of a PRACH used for transmitting the random access preambles by the radio communication terminal in a carrier and the carrier where the PRACH is located.

Various disclosures herein further provide a program for carrying out the communication method as described above and medium for storing the program.

The radio communication terminal, radio communication base station and communication method thereof, program for carrying out the communication method and medium for storing the program are capable of effectively performing random access in a CA system, so as to realize synchronization.

### BRIEF DESCRIPTION OF THE DRAWINGS

FIG. 1 is a schematic diagram of a random access procedure in the prior art;

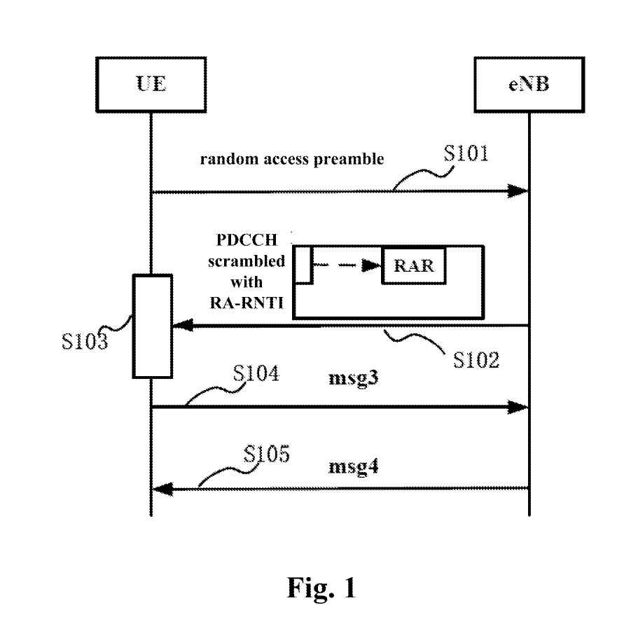

FIG. 2 is a graph showing a problem occurred in a random access procedure of the prior;

FIG. 3 is a block diagram of the UE of a first embodiment;

FIG. 4 is a block diagram of the eNB of a second embodiment;

FIG. 5 is a flowchart of the UE of a third embodiment;

FIG. 6 is a flowchart of the UE of a fourth embodiment;

FIG. 7 is a flowchart of the eNB of a fifth embodiment;

FIG. 8 is a flowchart of the eNB of a sixth embodiment; and

FIG. 9 is a schematic diagram of a random access procedure between the UE and the eNB of a seventh embodiment.

### DETAILED DESCRIPTION

Best modes shall be described below with reference to the accompanying drawings.

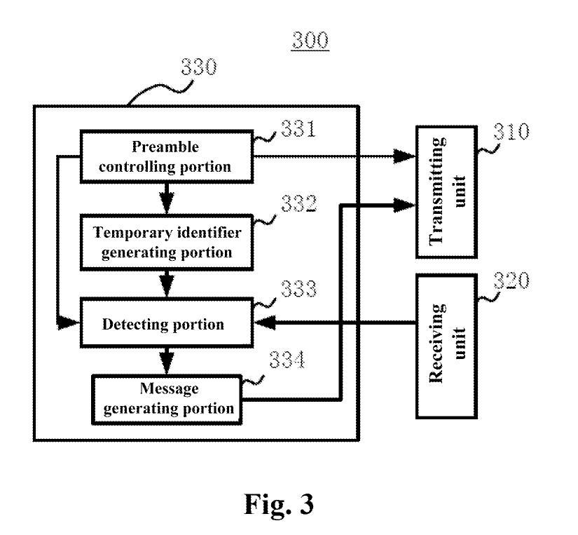

The structure of a UE 300 and an eNB 400 shall be described first taking a random access procedure in a contention-based as an example. FIG. 3 is a block diagram of the UE of a first embodiment.

As shown in FIG. 3, the UE 300 has a transmitting unit 310, a receiving unit 320 and a controlling unit 330. In this embodiment, the controlling unit 330 controls the transmitting unit 310 to use a plurality of uplink carriers to transmit preambles for performing random access.

The transmitting unit 310 transmits radio signals to the eNB under the control of the controlling unit 330, and the receiving unit 320 receives the radio signals transmitted from the eNB under the control of the controlling unit 330.

Preferably, the controlling unit 330 has a preamble controlling portion 331, a temporary identifier generating portion 332, a detecting portion 333 and a message generating portion 334. The preamble controlling portion 331 selects preambles for random access and a PRACH for transmitting the preambles, and outputs information on the selected preambles and PRACH to the transmitting unit 310. The transmitting unit 310 transmits the selected preambles to the eNB via the PRACH selected by the preamble controlling portion 331.

The temporary identifier generating portion 332 generates an RA-RNTI according to the PRACH selected by the preamble controlling portion 331 and information on carriers.

If the eNB receives the random access preambles of the UE 300, it generates an RA-RNTI identical to the RA-RNTI generated by the controlling unit 330 of the UE 300 according to the position of the PRACH used by the preambles in a carrier and information on the carrier where the PRACH is located, and uses the RA-RNTI to scramble the PDCCH belonging to the UE 300, and in a prescribed access response window, transmits the scrambled PDCCH and the RAR message specified by the PDCCH.

The detecting portion 333 detects the response sent by the eNB after the preambles and the PRACH are selected by the preamble controlling portion 331 and transmitted by the transmitting unit 310 to the eNB, and descrambles the PDCCH scrambled by the RA-RNTI according to the RA-RNTI generated by the temporary identifier generating portion 332, so as to obtain the response information belonging to the UE 300 itself. The message generating portion 334 transmits a message 3 (msg3) to the eNB for identity acknowledgement according to the preambles selected by the preamble controlling portion 331 and after the detecting portion 333 detects the response of the UE 300 itself, so as to fulfill subsequent processes of the random access procedure.

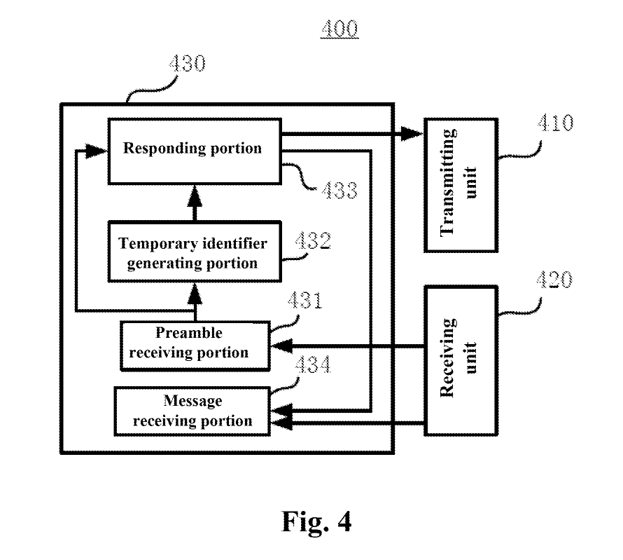

FIG. 4 is a block diagram of the eNB of a second embodiment. In this embodiment, a controlling unit 430 controls a receiving unit 420 to receive random access preambles from the UE 300 in a plurality of uplink carriers.

As shown in FIG. 4, an eNB 400 has a transmitting unit 410, a receiving unit 420 and a controlling unit 430. The transmitting unit 410 is configured to transmit radio signals, the receiving unit 420 is configured to receive radio signals, and the controlling unit 430 controls the transmitting unit 410 and the receiving unit 420, so as to realize communication of a radio communication network.

Preferably, the controlling unit 430 has a preamble receiving portion 431, a temporary identifier generating portion 432, a responding portion 433 and a message receiving portion 434. The preamble receiving portion 431 receives and detects the preambles transmitted from the UE 300 in random access, so as to obtain the PRACH used by the preambles and the carrier where the PRACH is located. The temporary identifier generating portion 432 generates a random access temporary identifier of the UE 300 according to the position of the PRACH used by the preambles obtained by the preamble receiving portion 431 in a carrier and information on the carrier where the PRACH is located. The responding portion 433 makes response to the preambles of the UE 300, generates RAR information of the UE 300 and scrambles a PDCCH via the random access temporary identifier generated by the temporary identifier generating portion 432, so that the UE 300 can only detect the PDCCH belonging to the UE 300, thereby finding the RAR of the UE 300. And at the same time, a random access response message is generated via the preambles received by the preamble receiving portion 431. Furthermore, after the responding portion 433 transmits the random access response message via the transmitting unit 410, the message receiving portion 434 detects the message 3 (Msg3) from the UE 300 via the receiving unit 420, so as to fulfill subsequent processes of the random access procedure.

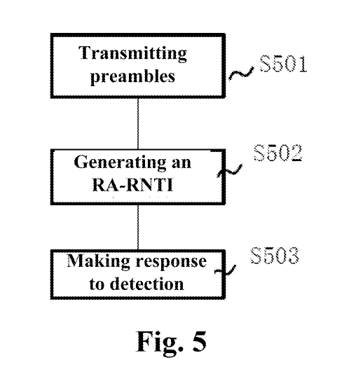

FIG. 5 is a flowchart of the UE of a third embodiment.

First, in step S501, the UE selects a PRACH of any one of a plurality of uplink carriers and preambles or uses the PRACH specified by an eNB and preambles, to transmit the preambles in the PRACH.

Then, in step S502, an RA-RNTI is generated according to the position of the PRACH in a carrier and the carrier where the PRACH is located.

Next, in step S503, a PDCCH from the eNB is detected by using the RA-RNTI generated in step S502, and hence a random access response transmitted by the eNB is obtained.

In a contention-based random access procedure, a UE selects a carrier and a PRACH in the carrier, and generates and transmits a message 3 (Msg3) after receiving a response from an eNB, so as to fulfill subsequent processes of a random access procedure.

The UE may also perform a non-contention-based random access procedure, and needs to receive preambles and a PRACH specified by the eNB before transmitting the preambles.

Following detailed description is given to an example of particular action flows of a UE in carrying out contention-based and non-contention-based random access procedures.

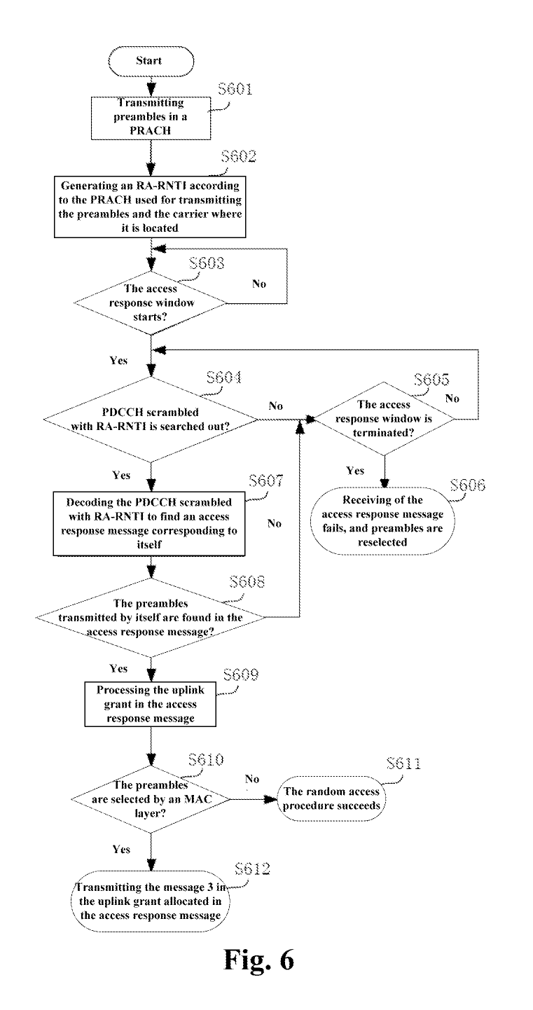

FIG. 6 is an action flowchart of the UE of a fourth embodiment. In this embodiment, the UE has a transmitting unit, a receiving unit and a controlling unit. The controlling unit of the UE controls the transmitting unit to use a plurality of uplink carriers to transmit preambles for performing random access. Different from the UE 300 in the first embodiment, the UE in this embodiment is capable of performing contention-based and non-contention-based random access procedures.

As shown in FIG. 6, in step S601, the controlling unit selects a PRACH of any one of a plurality of uplink carriers and preambles or uses the PRACH specified by an eNB and preambles, to control the transmitting unit to transmit the preambles in this PRACH.

Next, in step 602, the controlling unit generates an RA-RNTI according to said PRACH for transmitting preambles and information on the carrier where the PRACH is located.

In step 603, the controlling unit waits for an access response window of the eNB, and it the access response window starts, it enters into step S604.

In steps S604 and S605, the controlling unit continually detects a PDCCH scrambled with the RA-RNTI of the UE in the whole access response window, until the access response window is terminated. If in step S605, a PDCCH belonging to the UE is not found even when the access response window is terminated, it enters into step S606, in which it is judged that transmission of the preambles fails. If the controlling unit detects the PDCCH belonging to the UE in step S604, it enters into step S607.

In step S607, a preamble identifier of the UE provided by the eNB is detected according to a position indicated by a correctly descrambled PDCCH.

In step S608, if the preamble identifier is detected, it will be deemed that the transmission of preambles is successful, and it enters into step S609; if the preamble identifier of the UE is not found, it enters into step S605.

In step S609, the controlling unit detects RAR information according to an RAR position indicated by the correctly descrambled PDCCH, hence, the controlling unit is capable of adjusting uplink grant according to the RAR information.

Next, in step S610, whether the preambles are selected by an MAC layer is judged. For non-contention-based random access, as the preambles are specified by the eNB, the random access procedure is finished (step S611). For contention-based random access, as the preambles are selected by the MAC layer of the UE, it enters into step S612, in which the controlling unit controls to transmit a message 3 (Msg3) in the uplink grant allocated in the access response message, so as to fulfill subsequent processes of the random access procedure.

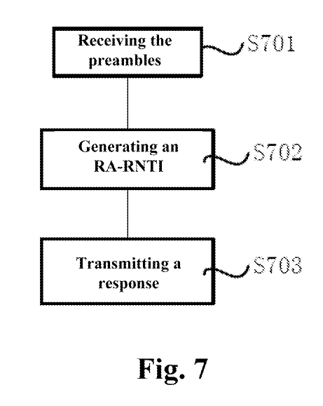

FIG. 7 is a flowchart of the eNB of a fifth embodiment.

First, in step S701, an eNB receives preambles for performing random access from a UE.

After receiving the preambles, in step S702, the eNB generates an RA-RNTI of the UE according to the PRACH used by said preambles and the carrier where the PRACH is located.

Next, in step S703, the eNB uses the RA-RNTI generated in step S702 to scramble a PDCCH of the UE, and transmits the PDCCH and corresponding access response information to the UE.

In a contention-based random access procedure, after transmitting a response, the eNB detects a message 3 (Msg3) from the UE, so as to fulfill subsequent processes of the random access procedure.

In the random access procedure, the eNB may also perform a non-contention-based random access procedure, and needs to transmit specified preambles and a PRACH to the UE before receiving the preambles from the UE.

Following detailed description is given to an example of particular action flows of an eNB in carrying out contention-based and non-contention-based random access procedures.

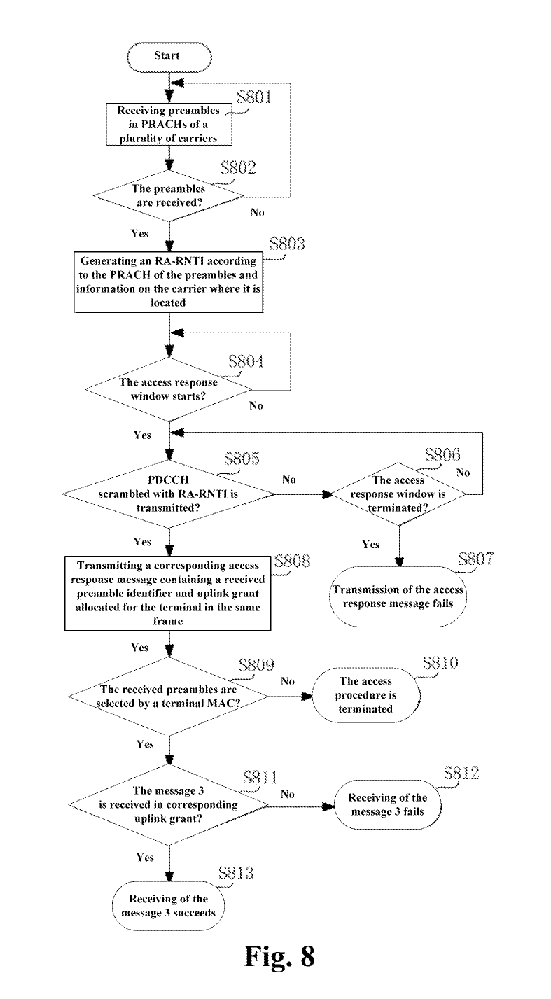

FIG. 8 is a flowchart of the eNB of a sixth embodiment. In this embodiment, the eNB has a transmitting unit, a receiving unit and a controlling unit. The controlling unit controls the receiving unit to receive random access preambles from a UE in a plurality of uplink carriers. Different from the eNB 400 in the second embodiment, the eNB in this embodiment is capable of performing contention-based and non-contention-based random access procedures.

As shown in FIG. 8, in step S801, the controlling unit of the eNB controls the receiving unit to receive random access preambles from the UE in a plurality of uplink carriers.

Next, in step S802, when the preambles from the UE are received, it enters into step S803, in which an RA-RNTI of the UE is generated according to the position of a PRACH for transmitting the preambles in a carrier and information on the carrier where the PRACH is located.

In step 804, the controlling unit waits for an access response window to start, and when the access response window is reached, if the eNB has no uplink grant to be allocated to the UE, it may make no response to the UE even if it correctly receives the preambles transmitted by the UE, until it is judged in step 806 that the access response window is terminated; then it enters into step 807, in which transmission of access response fails.

Wherein, step 803 may be executed after step 804, as long as it is executed before step 805, that is, before transmitting the PDCCH scrambled with the RA-RNTI.

If the controlling unit finishes scrambling the PDCCH of the UE before the termination of the access response window in step S805, it transmits RAR information of the UE at the position indicated by the PDCCH in step S808, the RAR information containing a preamble identifier of the UE and uplink grant allocated to the UE.

In step S809, the controlling unit judges whether the preambles of the UE are selected by an MAC layer of the UE. For non-contention-based random access, as the preambles are specified by the eNB, it enters into step S810, in which the random access procedure is finished. For contention-based random access, as the preambles are selected by the MAC layer of the UE, it enters into step S811, in which the message 3 (Msg3) transmitted by the UE after receiving the PDCCH and the RAR is waited for in the uplink grant given to the UE. After receiving the message 3 (Msg3) in step S813, subsequent processes of the random access procedure are fulfilled. If the message 3 (Msg3) is not received, it enters into step S812, in which receiving of the message 3 (Msg3) fails.

The RA-RNTIs at a UE side in the fifth embodiment and at an eNB side in the sixth embodiment are generated under the same conditions, thereby ensuring that the UE is capable of uniquely detecting the response belonging to itself from the eNB.

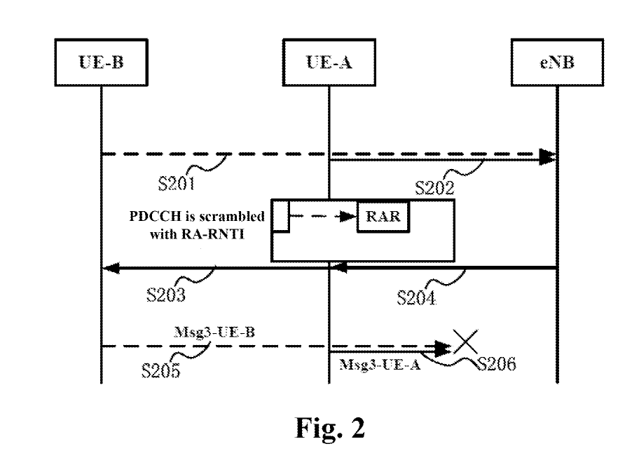

As described above, in performing random access, the controlling unit of the UE generates an RA-RNTI according to the position of the PRACH used for transmitting the random access preambles in a carrier and the carrier where the PRACH is located, so that the UE is capable of transmitting random access preambles in a plurality of carriers, with no occurrence of the error of random access as shown in FIG. 2.

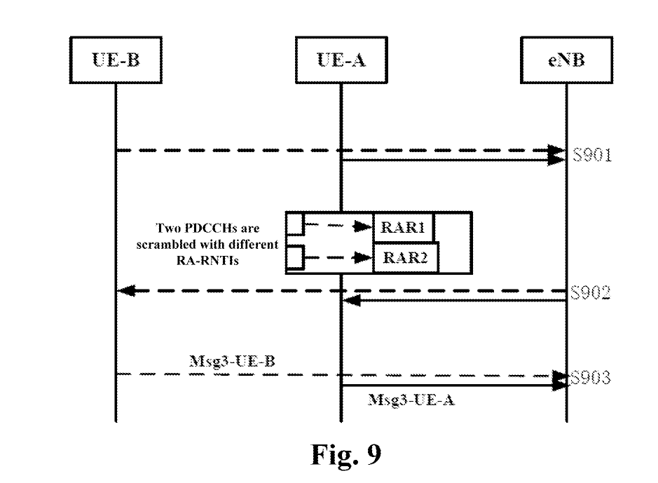

Following description is given with reference to FIG. 9 for flows of random access between UE-A and UE-B and the eNB 400 taking contention-based random access as an example

FIG. 9 is a schematic diagram of random access procedure between the UE and the eNB of a seventh embodiment.

In FIG. 9, the UE-A and UE-B have structures same as that of the UE 300 as described in the above embodiment.

In a contention-based random access procedure, in step S901, the UE-A and UE-B transmit random access preambles to the eNB 400 at the same positions in different carriers, that is, the same PRACH in different carriers.

As described above, after receiving preambles from the UE-A and UE-B, the eNB 400 generates RA-RNTI of the UE-A and RA-RNTI of the UE-B according to the positions of the PRACH used for transmitting respective random access preambles of the UE-A and UE-B in carriers and information on the carrier where the PRACH is located.

As information on carriers of each terminal for transmitting the preambles is used in generating the RA-RNTI of the UE-A and the RA-RNTI of UE-B, different RA-RNTIs may be generated for the UE-A and UE-B.

On the other hand, in the UE-A and UE-B, similar to the eNB 400, RA-RNTI belonging to itself may be generated respectively according to the PRACH for transmitting preamble selected respectively and information on the carrier where this PRACH is located.

In step S902, in transmitting respective responses to the UE-A and UE-B in the access response window, the eNB 400 uses respectively the RA-RNTIs of the UE-A and UE-B to scramble the PDCCHs belonging to the UE-A and UE-B, thereby transmits respectively RAR1 and RAR2 to the UE-A and UE-B.

In step S902, the eNB may respectively response to the UE-A and UE-B in the same subframe, and may also may respectively response to the UE-A and UE-B in different subframes, as shown in FIG. 9; however, it must be ensured that the response messages are within the response window.

As the RA-RNTIs of the UE-A and UE-B are different, the UE-A and UE-B may correctly descramble the PDCCHs belonging to themselves, respectively, and find respective RAR information at the positions indicated by respective PDCCHs.

After performing adjustment according to the respective RAR information, the UE-A and UE-B respectively transmit messages 3 (Msg3) to the eNB 400 in step S903. As the uplink grant allocated in the RAR information of the UE-A and UE-B is different, the respective messages 3(Msg3) will not collide, thereby smoothly fulfilling the random access procedure.

As described above, during the random access procedure, the eNB and the UE generate an RA-RNTI of the UE according to the position of the PRACH used by the UE for transmitting preambles in the carrier and the carrier information of the PRACH, so that the messages 3 of the UE-A and UE-B are avoided from colliding and a plurality of uplink carriers may be used to perform random access procedures simultaneously, enabling more users to fulfill random access simultaneously, and improving the capability of the radio communication system in processing random access.

Following detailed description is given for particular embodiments herein of generating RA-RNTIs at the UE side and the eNB side.

### Embodiment 1

It is provided in Rel. 9 of 3GPP that each frame in a carrier is divided into 10 subframes in time domain, and each subframe is divided into 6 channels in frequency domain. Hence, the RA-RNTI generated may be expressed by formula (14) as below:

RA-RNTI=1+t_{—}id+10*f_{—}id+60° Cell-Index (14)

where, t_id is the index of the first subframe where a specific PRACH (i.e. the PRACH for transmitting the preambles) is located, f_id is the index of the PRACH within that subframe, and Cell-Index is an identifier of the carrier where the PRACH is located.

Furthermore, as it is provided in 3GPP that there are 10 subframes for a frame in time domain, i.e. 0≦t_id<10, and there are 6 channels in frequency domain in ascending order, i.e. 0≦f_id<6, in case of single carrier, the maximum value of the RA-RNTI becomes 60. By using formula (14), the RA-RNTIs generated at the UE side and the eNB side in performing random access are enabled to correspond to all the applicable PRACHs one by one in all the carriers, thereby preventing errors in the random access procedure. However, the coefficient of the third item of formula (14), 60*Cell-Index, is not limited to the maximum value “60”, the present invent may be carried out only if it is not less than the maximum value.

Furthermore, as it is provided in 3GPP that the bit length of the RA-RNTI is 16 bits, and even though it is provided in the CA of Rel. 10 of 3GPP that the UE may operate in a bandwidth of at most 100 MHz, i.e. at most 5 carriers may be aggregated, the number of the RA-RNTIs generated will not exceed the domain of 16 bits as provided in 3GPP, i.e. the number of 2¹⁶, if all of the 5 carriers are taken as the primary carriers capable of initiating random access. Hence, certain embodiments are compatible with the releases of 3GPP, that is, the eNB is capable of simultaneously receiving random access preambles in a plurality of carriers and making responses while ensuring providing services bases on the prior art; and the UE is capable of and may be configured to simultaneously transmit random access preambles in a plurality of carriers in performing random access with the eNB, and is compatible with the eNB providing services bases on the prior art.

### Embodiment 2

As another embodiment, it is provided in 3GPP that the bit length of the RA-RNTI is 16 bits. In this embodiment, the bit length of the RA-RNTI is extended to more bits from the existing 16 bits, such as 20 bits, or 24 bits, etc. Hence, the RA-RNTI generated may be expressed as below:

RA-RNTI=1+t_{—}id+10*f_{—}id+Cell-Index*2^{T} (15)

where, T is a positive integer not less than the bit length of the RA-RNTI as provided in 3GPP; that is, when certain embodiments are carried out on the basis of the existing 3GPP standard, T may be a positive integer not less than 16 after the existing RA-RNTI is extended from 16 bits.

According to this embodiment, the RA-RNTI is enabled to support more applicable PRACHs by extending the RA-RNTI to more bits from the bit length described in existing standard.

### Embodiment 3

In this embodiment, an RA-RNTI is generated according to the index of the first subframe where a PRACH for transmitting random access preambles is located and the index of said PRACH in all the PRACHs in all the carriers. RA-RNTIs uniquely corresponding to all the PRACHs in all the carriers are obtained by arranging all the PRACHs in the frequency domain.

Particularly, on the basis of the provisions of the existing 3GPP that there are 10 subframes in a frame in time domain, i.e. 0≦t_id<10, and there are 6 channels in frequency domain in ascending order, i.e. 0≦f_id<6, in case of 5 carriers are aggregated as provided in Rel. 10 of 3GPP, the RA-RNTI of this embodiment may be expressed as below:

RA-RNTI=1+t_{—}id+10*f_{—}id_new (16)

where, f_id_new is a index of a specified PRACH in all the PRACHs in all the carriers that can uniquely identify this PRACH and arranged in ascending order of frequency domain; and as there are 6 channels for one frame in frequency domain and 5 carriers are aggregated, 0≦f_id_new<30, and for the PRACHs, they are normally arranged in ascending order of frequency domain.

According to this embodiment, the RA-RNTIs generated at the UE side and the eNB side in performing random access are enabled to uniquely correspond to all the applicable PRACHs one by one in all the carriers, thereby effectively performing random access in using a plurality of uplink carriers to perform random access.

According to certain embodiments, the UE and the eNB are respectively enabled to transmit and receive random access preambles in a plurality of carriers and fulfill the random access procedure. Therefore, more users are permitted to perform random access simultaneously, thereby improving greatly the capability of the radio communication system in processing random access, and improving rate of success of random access.

Furthermore, according to certain embodiments a program for carrying out the method of communication between a radio communication terminal and a radio communication base station and a storage medium for storing the program. The storage medium may be any storage medium, such a CD, a hard disk, and a flash memory, etc.

The above embodiments are for explanation only, and are not intended to limit the present claimed invention. The protection scope is defined by the appended claims. The principle and idea may also be carried out in manners equivalent or similar to the above embodiments.

1. A radio communication terminal for communicating with a radio communication base station, comprising:
a transmitting unit configured to transmit a random access preamble to the radio communication base station;
a receiving unit configured to receive a response message from the radio communication base station; and
a controlling unit configured to generate a random access temporary identifier to obtain the response message, so as to realize synchronization;
wherein the controlling unit controls the transmitting unit to transmit the random access preamble in any one of a plurality of carriers; and
the controlling unit generates the random access temporary identifier according to a position of a PRACH used for transmitting the random access preamble in a carrier and the carrier where the PRACH is located.

2. The radio communication terminal according to claim 1, further comprising:
the controlling unit generates the random access temporary identifier according to the index of the first subframe where the PRACH is located, the index of the PRACH obtained by arranging in the subframe in ascending order of frequency domain and an identifier of the carrier where the PRACH is located.

3. The radio communication terminal according to claim 1, further comprising:
the random access temporary identifier is calculated according to formula (1):
1+t_{—}id+X*f_{—}id+Y*Cell-Index (1)
where,
t_id is an index of the first subframe where the PRACH is located,
f_id is the index of the PRACH obtained by arranging in the subframe in ascending order of frequency domain,
Cell-Index is the identifier of the carrier where the PRACH is located,
X is the number of subframes in one frame, and
Y is an integer not less than the maximum value of the random access temporary identifier in a single carrier.

4. The radio communication terminal according to claim 2, further comprising:
the random access temporary identifier is calculated according to formula (2):
1+t_{—}id+X*f_{—}id+Cell-Index*2^{T} (2)
where,
t_id is the index of the first subframe where the PRACH is located,
f_id is the index of the PRACH obtained by arranging in the subframe in ascending order of frequency domain,
Cell-Index is the identifier of the carrier where the PRACH is located,
X is the number of subframes in one frame, and
T is a positive integer not less than the specified bit length of the random access temporary identifier following provisions.

5. The radio communication terminal according to claim 1, further comprising:
the controlling unit generates the random access temporary identifier according to the index of the first subframe where the PRACH is located and the index of the PRACH obtained by arranging in all the PRACHs in all the carriers in ascending order of frequency domain.

6. The radio communication terminal according to claim 5, further comprising:
the random access temporary identifier is calculated according to formula (3) below:
1+t_{—}id+X*f_{—}id_new (3)
where,
t_id is the index of the first subframe where the PRACH is located,
f_id_new is the index of the PRACH obtained by arranging in all the PRACHs in all the carriers in ascending order of frequency domain, and
X is the number of subframes in one frame.

7. A radio communication base station for communicating with a radio communication terminal, comprising:
a receiving unit configured to receive a random access preamble from the radio communication terminal;
a controlling unit configured to generate a random access temporary identifier of the radio communication terminal and a response message for the random access preamble, and use the random access temporary identifier to scramble the response message; and
a transmitting unit configured to transmit the scrambled response message to the radio communication terminal;
wherein
the controlling unit controls the receiving unit to receive the random access preamble in multiple carriers, and
the controlling unit generates the random access temporary identifier of the radio communication terminal according to a position of a PRACH used for transmitting the random access preamble by the radio communication terminal in a carrier and the carrier where the PRACH is located.

8. The radio communication base station according to claim 7, further comprising:
the controlling unit generates the random access temporary identifier according to the index of the first subframe where the PRACH is located, the index of the PRACH obtained by arranging in the subframe in ascending order of frequency domain and an identifier of the carrier where the PRACH is located.

9. The radio communication base station according to claim 8, further comprising:
the random access temporary identifier is calculated according to formula (4):
1+t_{—}id+X*f_{—}id+Y*Cell-Index (4)
where,
t_id is an index of the first subframe where the PRACH is located,
f_id is the index of the PRACH obtained by arranging in the subframe in ascending order of frequency domain,
Cell-Index is the identifier of the carrier where the PRACH is located,
X is the number of subframes in one frame, and
Y is an integer not less than the maximum value of the random access temporary identifier in a single carrier.

10. The radio communication base station according to claim 8, further comprising:
the random access temporary identifier is calculated according to formula (5):
1+t_{—}id+X*f_{—}id+Cell-Index*2^{T} (5)
where,
t_id is the index of the first subframe where the PRACH is located,
f_id is the index of the PRACH obtained by arranging in the subframe in ascending order of frequency domain,
Cell-Index is the identifier of the carrier where the PRACH is located,
X is the number of subframes in one frame, and
T is a positive integer not less than the specified bit length of the random access temporary identifier following provisions.

11. The radio communication base station according to claim 7, further comprising:
the controlling unit generates the random access temporary identifier according to the index of the first subframe where the PRACH is located and the index of the PRACH obtained by arranging in all the PRACHs in all the carriers in ascending order of frequency domain.

12. The radio communication base station according to claim 11, further comprising:
the random access temporary identifier is calculated according to formula (6):
1+t_{—}id+X*f_{—}id_new (6)
where,
t_id is the index of the first subframe where the PRACH is located,
f_id_new is the index of the PRACH obtained by arranging in all the PRACHs in all the carriers in ascending order of frequency domain, and
X is the number of subframes in one frame.

13. A radio communication terminal communication method for performing communication between a radio communication terminal and a radio communication base station, comprising:
in performing random access,
transmitting a random access preamble to the radio communication base station by the radio communication terminal in any one of a plurality of carriers, and
generating a random access temporary identifier by the radio communication terminal according to a position of a PRACH used for transmitting the random access preamble in a carrier and the carrier where the PRACH is located.

14. The radio communication terminal communication method according to claim 13, further comprising:
generating the random access temporary identifier according to the index of the first subframe where the PRACH is located, the index of the PRACH obtained by arranging in the subframe in ascending order of frequency domain and an identifier of the carrier where the PRACH is located.

15. The radio communication terminal communication method according to claim 14, further comprising:
the random access temporary identifier is calculated according to formula (7):
1+t_{—}id+X*f_{—}id+Y*Cell-Index (7)
where,
t_id is a index of the first subframe where the PRACH is located,
f_id is the index of the PRACH obtained by arranging in the subframe in ascending order of frequency domain,
Cell-Index is the identifier of the carrier where the PRACH is located,
X is the number of subframes in one frame, and
Y is an integer not less than the maximum value of the random access temporary identifier in a single carrier.

16. The radio communication terminal communication method according to claim 14, further comprising:
the random access temporary identifier is calculated according to formula (8):
1+t_{—}id+X*f_{—}id+Cell-Index*2^{T} (8)
where,
t_id is the index of the first subframe where the PRACH is located,
f_id is the index of the PRACH obtained by arranging in the subframe in ascending order of frequency domain,
Cell-Index is the identifier of the carrier where the PRACH is located,
X is the number of subframes in one frame, and
T is a positive integer not less than the specified bit length of the random access temporary identifier following provisions.

17. The radio communication terminal communication method according to claim 13, further comprising:
the random access temporary identifier is generated according to the index of the first subframe where the PRACH is located and the index of the PRACH obtained by arranging in all the PRACHs in all the carriers in ascending order of frequency domain.

18. The radio communication terminal communication method according to claim 17, further comprising:
the random access temporary identifier is calculated according to formula (9):
1+t_{—}id+X*f_{—}id_new (9)
where,
t_id is a index of the first subframe where the PRACH is located,
f_id_new is the index of the PRACH obtained by arranging in all the PRACHs in all the carriers in ascending order of frequency domain, and
X is the number of subframes in a frame.

19. A radio communication base station communication method for performing communication between a radio communication base station and a radio communication terminal, comprising
in performing random access,
receiving in a plurality of carriers, by the radio communication base station, random access preambles transmitted by the radio communication terminal, and
generating a random access temporary identifier of the radio communication terminal by the radio communication base station according to a position of a PRACH used for transmitting the random access preambles by the radio communication terminal in a carrier and the carrier where the PRACH is located.

20. The radio communication base station communication method according to claim 19, further comprising:
generating the random access temporary identifier according to the index of the first subframe where the PRACH is located, the index of the PRACH obtained by arranging in the subframe in ascending order of frequency domain and an identifier of the carrier where the PRACH is located.

21. The radio communication base station communication method according to claim 20, further comprising:
the random access temporary identifier is calculated according to formula (10):
1+t_{—}id+X*f_{—}id+Y*Cell-Index (10)
where,
t_id is a index of the first subframe where the PRACH is located,
f_id is the index of the PRACH obtained by arranging in the subframe in ascending order of frequency domain,
Cell-Index is the identifier of the carrier where the PRACH is located,
X is the number of subframes in one frame, and
Y is an integer not less than the maximum value of the random access temporary identifier in a single carrier.

22. The radio communication base station communication method according to claim 20, further comprising:
the random access temporary identifier is calculated according to formula (2):
1+t_{—}id+X*f_{—}id+Cell-Index*2^{T} (2)
where,
t_id is a index of the first subframe where the PRACH is located,
f_id is the index of the PRACH obtained by arranging in the subframe in ascending order of frequency domain,
Cell-Index is the identifier of the carrier where the PRACH is located,
X is the number of subframes in a frame, and
T is a positive integer not less than the specified bit length of the random access temporary identifier following provisions.

23. The radio communication base station communication method according to claim 19, further comprising:
generating the random access temporary identifier according to the index of the first subframe where the PRACH is located and the index of the PRACH obtained by arranging in all the PRACHs in all the carriers in ascending order of frequency domain.

24. The radio communication base station communication method according to claim 23, further comprising:
the random access temporary identifier is calculated according to formula (3) below:
1+t_{—}id+X*f_{—}id_new (3)
where,
t_id is the index of the first subframe where the PRACH is located,
f_id_new is the index of the PRACH obtained by arranging in all the PRACHs in all the carriers in ascending order of frequency domain, and
X is the number of subframes in one frame.

25. A computer readable medium comprising a program for driving a computer to carry out a radio communication terminal communication method, the radio communication terminal communication method comprising:
in performing random access,
transmitting random access preambles to the radio communication base station by the radio communication terminal in any one of a plurality of carriers, and
generating a random access temporary identifier by the radio communication terminal according to a position of a PRACH used for transmitting the random access preambles in a carrier and the carrier where the PRACH is located.

26. A computer readable medium comprising a program for driving a computer to carry out a radio communication base station communication method, the radio communication base station communication method comprising:
in performing random access,
receiving in a plurality of carriers, by the radio communication base station, random access preambles transmitted by the radio communication terminal, and
generating a random access temporary identifier of the radio communication terminal by the radio communication base station according to a position of a PRACH used for transmitting the random access preambles by the radio communication terminal in a carrier and the carrier where the PRACH is located.
